(19) United States
(12) Patent Application Publication
(10) Pub. No.: US 2007/0174138 A1
(43) Pub. Date: Jul. 26, 2007

(54) Web model and method implementing technical merit index to assist in evaluating engineering products

(75) Inventors: Hauhua Lee, Houston, TX (US); Richard John Keck, Houston, TX (US); Robert Allen Baten, Baytown, TX (US); Fuhua Zhou, Houston, TX (US)

Correspondence Address: NIXON & VANDERHYE P.C., 901 NORTH GLEBE ROAD, 11TH FLOOR, ARLINGTON, VA, 22203, US

(73) Assignee: General Electrics Company, Schenectady, NY (US)

(21) Appl. No.: 11/322,367

(22) Filed: Jan. 3, 2006

(51) Int. Cl. G06Q 30/00

(52) U.S. Cl. 705/27

(57) ABSTRACT

A technical merit index-based web model for implementing a technical merit index tool facilitates product selection. A technical user input section is populated via a global network with defined selection factors and desired values for each of the selection factors for a product to be selected. A product supplier input section is populated via the global network with product specifications relating to the defined selection factors. A technical merit index is determined for each candidate product based on a summation of normalized product specifications for each of the defined selection factors relative to the desired values. The web model and method facilitate product selection using objective criteria that is weighted based on the importance of the respective selection factors.

### RELATED APPLICATION(S)

This application is related to U.S. application Ser. No. 11/---,--- (attorney docket 839-1786) and U.S. application Ser. No. 11/---,--- (attorney docket 839-1790).

### BACKGROUND OF THE INVENTION

The invention relates to facilitating the selection of products such as engineering products and, more particularly, to a web model system and method that quantify a product technical merit index based on product specifications for defined selection factors relative to desired values.

Selecting components such as pumps, motors, control valves and the like for engineering systems is often a challenging task that requires substantial domain knowledge and experience. In considering products for incorporation into engineering systems, important variables differ among product suppliers, and it has been a challenge to confidently determine which product is best suited for the engineering system. For example, in selecting a hydraulic pump, important selection factors may include outlet pressure, speed, flow ratio, and the like. Available products may satisfy requirements for some of the selection criteria while falling short on others. The engineer is thus faced with the task of determining where to compromise in the desired specifications while selecting a product that would be suitable for the intended application.

To date, common features found in e-business websites for engineering products are mainly the catalog search (including filtering) capability. They can search on general technical specifications and pricing information, and some include extensions for searches across multiple suppliers, or searches based on certain interactive questions (like expert systems). Such websites, however, offer little help in quantitatively “comparing” candidate products, and the selection is still dependent upon the user's knowledge and experience to evaluate the candidates. Despite that many websites offer educational materials to assist users in becoming knowledgeable about the products, the evaluation knowledge continues to be a gap between buyers and sellers.

### BRIEF DESCRIPTION OF THE INVENTION

In an exemplary embodiment of the invention, a method of implementing a technical merit index tool over a global network facilitates product selection. The method includes populating via the global network a technical user input section with defined selection factors and desired values for each of the selection factors for a product to be selected, and populating via the global network a product supplier input section with product specifications relating to the defined selection factors. A technical merit index is determined for each candidate product based on a summation of normalized product specifications for each of the defined selection factors relative to the desired values.

In another exemplary embodiment of the invention, a computer system for implementing a technical merit index tool includes at least a first user computer running a computer program that supplies data for populating a technical user input section with defined selection factors and desired values for each of the selection factors for a product to be selected. At least a second user computer running a computer program supplies data for populating a product supplier input section with product specifications relating to the defined selection factors. A web server runs a server program, and the at least first and second user computers and the web server are interconnected by a computer network. The web server receives and processes the technical user input section data and the product supplier input section data and determines a technical merit index for each candidate product based on a summation of normalized product specifications for each of the defined selection factors relative to the desired value. A database server stores all the technical user input section data, the product supplier input section data and technical merit index for each candidate product.

In still another exemplary embodiment of the invention, a method of quantifying product technical merit to facilitate product selection includes the steps of (a) a technical user identifying selection factors for a product to be selected; (b) the technical user establishing a weight factor relating to an importance level for each of the identified selection factors; (c) the technical user defining ranking criteria for each of the identified selection factors including at least two levels as high (H) and low (L); (d) the technical user populating via a global network a technical user input section including the selection factors identified in step (a), the weight factor for each of the identified selection factors established in step (b), and the ranking criteria defined in step (c); (e) a supplier populating via the global network a product supplier input section with product specifications relating to the identified selection factors and supporting documentation; (f) determining a technical merit index for each candidate product based on a summation of normalized product specifications for each of the identified selection factors weighted by the respective weight factor and multiplied by the respective ranking criteria; and (g) selecting one of the candidate products based at least partly on a comparison the technical merit index of each candidate product.

### BRIEF DESCRIPTION OF THE DRAWINGS

FIG. 1 is an exemplary spreadsheet application of the technical merit index tool of the invention;

FIG. 2 is a flow chart illustrating a usage phase and development phase for the technical merit index tool;

FIG. 3 is a detailed schematic illustration of a computer system; and

FIG. 4 is a schematic block diagram of the web model of the invention.

### DETAILED DESCRIPTION OF THE INVENTION

Technical merit index (TMI) focuses on “technical” aspect evaluations in meeting engineering requirements. Examples of technical factors include product performance such as efficiency, internal design/structure, materials of key parts, reliability information like MTBF (mean time between failure) and MTTR (mean time to repair), etc. Non-technical factors such as cost, warranty, terms and conditions, and non-technical personal-preference like color or style, etc. are intentionally left out as they are considered orthogonal to technical factors and should be evaluated in a separate dimension.

A TMI-based web model and method extends the current e-business models on the internet. The model offers users (buyers) technical evaluation knowledge that is specific to the user's requirements. Additionally, the model establishes common protocol on product specification description across different product suppliers (sellers).

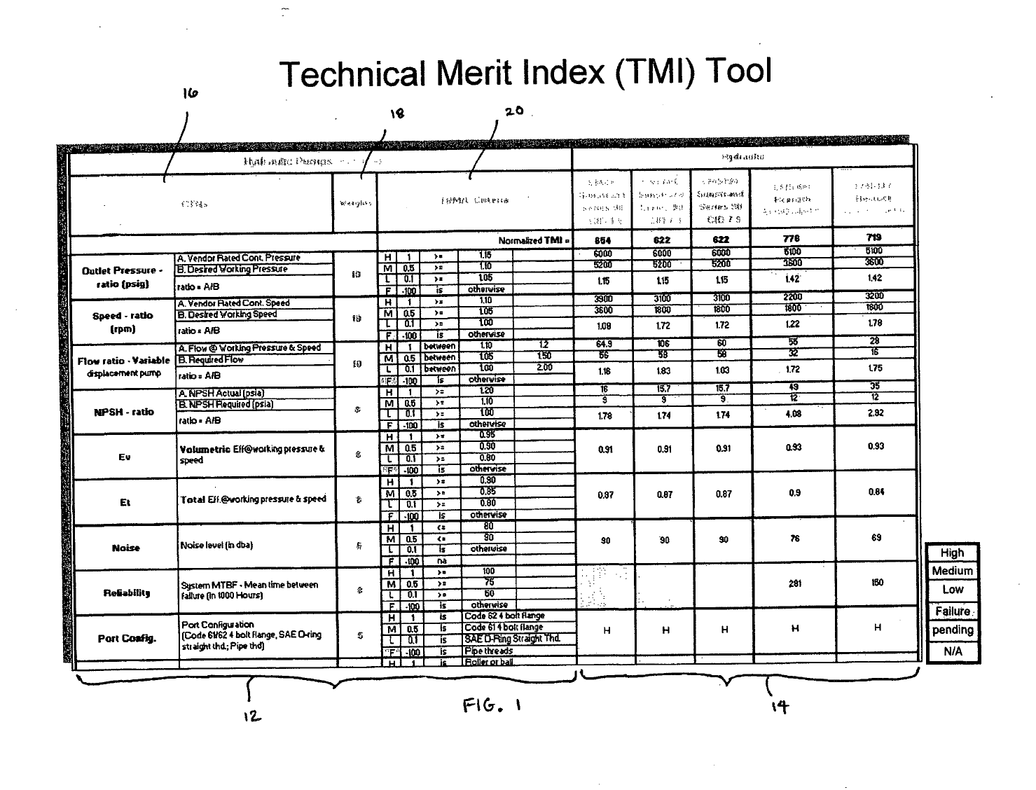

In a preferred application, TMI is defined with respect to specific engineering components and applications, such as pumps used for pumping hydraulic fluid (hydraulic pump), for pumping fuel (fuel pump), for pumping lubrication material (lube pump) or control valves for handling liquid fuel or high pressure water, and the like. FIG. 1 illustrates the TMI tool in a spreadsheet application with reference to an evaluation of hydraulic pumps. Any suitable spreadsheet application may be used, and many such applications are available; thus, details of the use and operation of a spreadsheet application will not be described. An exemplary spreadsheet application suitable for the TMI tool of the invention is an Excel-based application. In such an application, data input into the input cells of the spreadsheet are processed via a processor such as a macro VBA function according to user-input data.

With reference to FIG. 1, the TMI tool includes a technical user input section 12 and a product supplier section 14. The technical user input section 12 includes defined selection factors and desired values for each of the selection factors for a product to be selected. These data are input on the user side by experienced personnel, such as senior engineers or the like for engineering products.

As shown in FIG. 1, the technical user input section 12 lists a plurality of identified critical selection factors 16 for the target component and application. For each of the identified selection factors 16, a weight factor 18 relating to an importance level is established. The weight factors 18 may vary from, for example, 1-10, with 10 being a maximum for an indication that the particular selection factor is of maximum importance in selecting the product.

The technical user input section 12 also includes ranking criteria 20 defined for each of the identified selection factors 16. The ranking factors establish boundaries and tolerances around the desired value for each of the selection factors 16. For example, in the hydraulic pump example illustrated in FIG. 1, a selection factor of maximum importance (indicated by the weight factor 18 listed as ‘10’) is an outlet pressure ratio, which is listed as a ratio of the vendor rated continuous pressure to the desired working pressure. The ranking criteria 20 are divided into high (H), medium (M), low (L) and fail (F), although more or fewer ranking criteria may be utilized. The experienced personnel determine what values of outlet pressure ratio would fall under which ranking criteria. In the example shown in FIG. 1, an outlet pressure ratio greater than or equal to 1.15 is considered high (H), a pressure ratio within the range of [1.1, 1.15] is considered medium (M), an outlet pressure ratio within the range of [1.05, 1.1] is considered low (L), and any outlet pressure ratio less than 1.05 is considered fail (F). The ranking criteria 20 includes a multiplication factor for each ranking, which in the example shown is H=1, M=0.5, L=0.1, and F=−100. These values, of course, could be varied by application or customized for each selection factor 16. In this manner, products having specifications that meet or exceed more important selection factors will be favored in the technical merit index analysis.

The product supplier input section 14 includes product specifications typically provided by the product supplier relating to each of the defined selection factors 16. In the example shown in FIG. 1, there are five hydraulic pump candidates being considered. The selection factor data, such as outlet pressure ratio, is provided by the supplier. With the data input into the spreadsheet, candidate products are evaluated against the predefined ranking criteria 20 for each of the selection factors 16, and the TMI tool obtains TMI scores via a weighted summation of all grades. The raw scores are then normalized to between 0 and 1000, where ‘1000’ represents a perfect score where the candidate is rated ‘H’ for every selection factor 16. A ‘0’ results from the case where at least one of the selection factors 16 is rated ‘F’. If all of the selection factors 16 are rated ‘M’, the score would fall around 500. If all of the selection factors are rated ‘L’, the score would fall around 100.

In analyzing the technical merit index for each of the candidate products, engineering personnel may define a technical qualification threshold as a minimum acceptable technical merit index based on use experience including both success and failure cases and possibly additional statistical analysis such as a linear regression model of the success/failure cases. In the example shown in FIG. 1, assuming a technical qualification threshold was set at TMI=650, two of the candidate products would be immediately disqualified. Subsequently, the remaining candidate products can be evaluated based on engineer experience with a particular product or brand, or other non-technical factors such as cost, etc. discussed above.

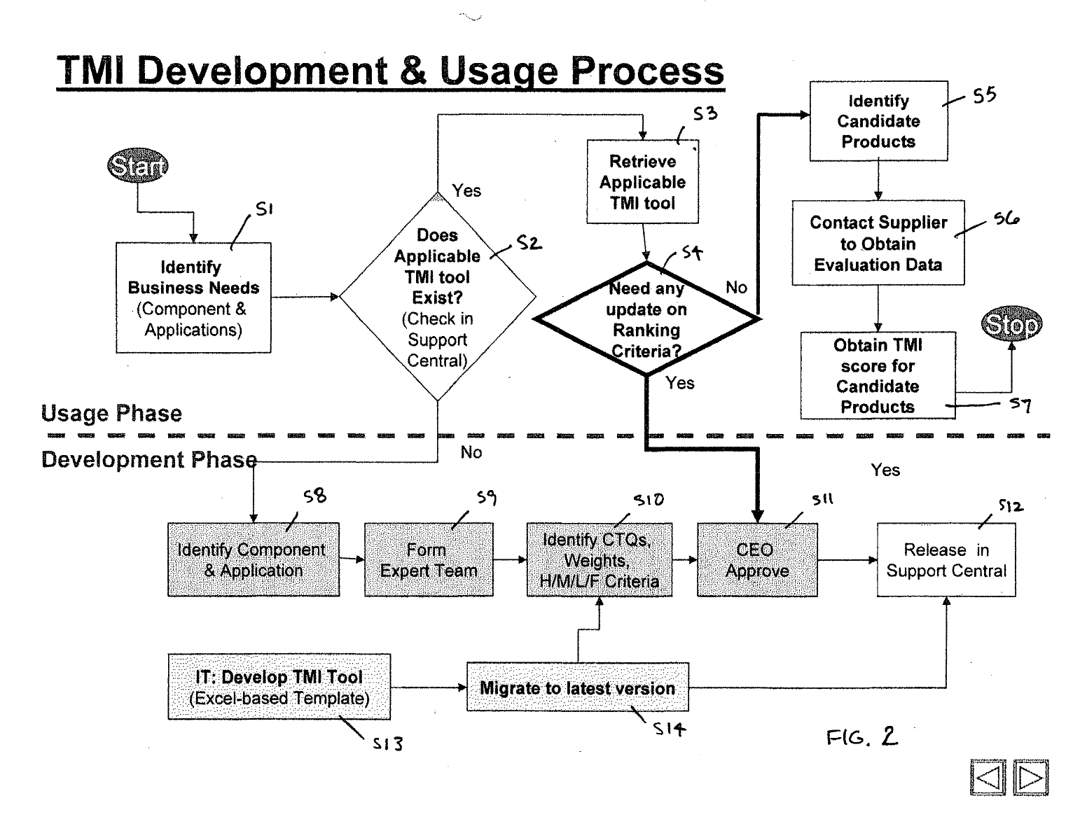

FIG. 2 is a flow chart illustrating a usage phase and development phase of the technical merit index tool. After a business need for a particular component and its application is identified (step S1), a determination is made whether an applicable TMI tool already exists (step S2). If not, the TMI tool for the desired product is developed in a development phase (discussed in more detail below). If so (YES in step S2), the applicable TMI tool is retrieved (step S3), and it is validated whether the selection factors and ranking criteria are all up to date and reflecting the latest technology available (example of such needs is in selecting personal computer, the ranking criteria for CPU and memory should reflect the newest technology) (step S4). If so (YES in step S4), updates are input and appropriate approvals are obtained (step S11), and the updated TMI tool is released for access and use (step S12). If updates are not necessary (NO in step S4), candidate products are identified (step S5). The product supplier input section 14 is then populated with product data from the supplier (step S6). The tool then obtains TMI scores for the candidate products (step S7), and an evaluation and selection of the candidate product can be carried out.

If an applicable TMI tool does not exist (NO in step S2), the TMI tool can be developed in a development phase where the component and application are identified (step S8), and a team of experienced personnel or “expert team” is formed to identify critical selection factors 16, weight factors 18, and ranking criteria 20 (steps S9 and S10). Appropriate approvals are obtained (step S11), and the TMI tool is released for access and use (step S12).

From a technical standpoint in the development phase, the TMI tool is developed using a known spreadsheet product (step S13) and the tool can be customized to different applications (step S14).

The web model implementing TMI in the diagrams of FIGS. 1 and 2 is preferably a three-tier web-based application. The user browser requests information from a web server. The web server sends the requested data from a database server back to the browser client and the browser client then interprets and displays the data on the user's computer screen. The process is as follows:

1. The user runs a web browser program on his/her computer.

2. The user connects to the web server computer (e.g., via the Internet). Connection to the web server computer may be conditioned upon the correct entry of a password as is well known.

3. The user requests a page from the web server computer. The user's browser sends a message to the server computer that includes the following:
the transfer protocol (e.g., http://); and
the address, or Uniform Resource Locator (URL).

4. The web server computer receives the user's request and retrieves the requested page, which is composed, for example, in HTML (Hypertext Markup Language) and ASP or JSP forms, etc.

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the web server loads and runs the program. This process usually creates a dynamic HTML page “on the fly” that contains the results of the program's action (e.g., the search results), and then sends those results back to the browser.

Browser programs suitable for use in connection with the account management system of the present invention include Netscape® Navigator available from Netscape® Communications Corporation and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the web server could be provided.

It will be recognized by those in the art that various tools are readily available to create web pages for accessing data stored on a server and that such tools may be used to develop and implement the account management system described below and illustrated in the accompanying drawings.

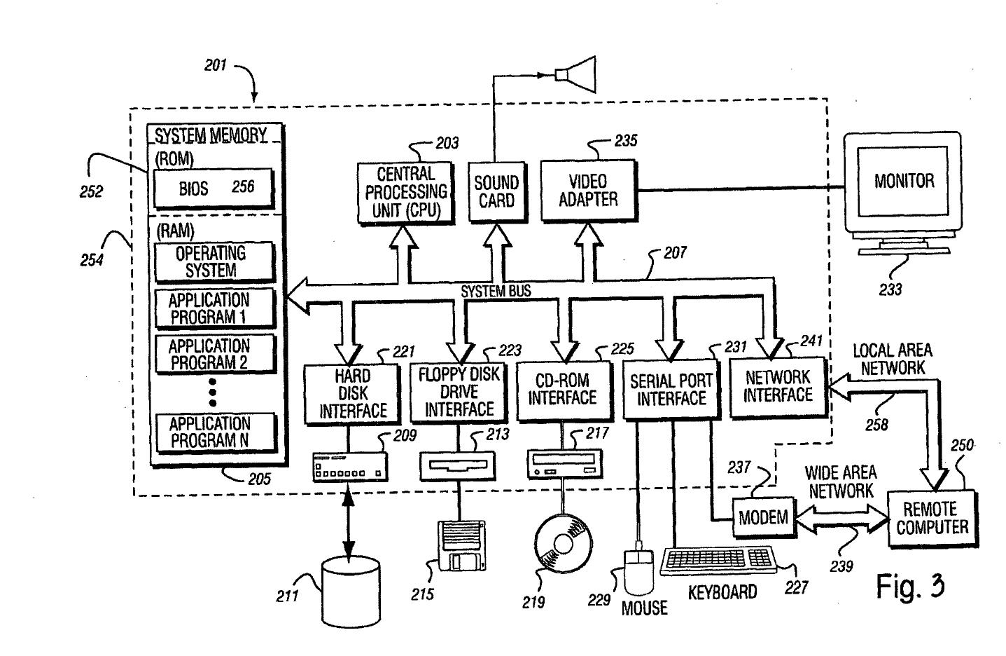

FIG. 3 generally illustrates a computer system 201 suitable for use as the client and server components of the account management system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem 237 or other means for establishing communications over the wide area network 252, such as the Internet. The modem 237, which may be internal or external, is connected to the system bus 207 via the serial port interface 231. A network interface 256 may also be provided for allowing the computer system 201 to communicate with a remote computing device 250 via a local area network 258 (or such communication may be via the wide area network 252 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used and the invention is not limited in this respect.

It has been a challenge in interpreting product specifications, as different suppliers often describe the product specifications in different ways. Such differences may be as trivial as using different metrics or terminology, or as sophisticated as requiring good knowledge to interpret. For example, MTTR for overall pump versus for bearing only; lifting data for motors with direct drive versus belted drive; etc. All such knowledge can be captured in the TMI tool, which is easy to maintain, validate and understand.

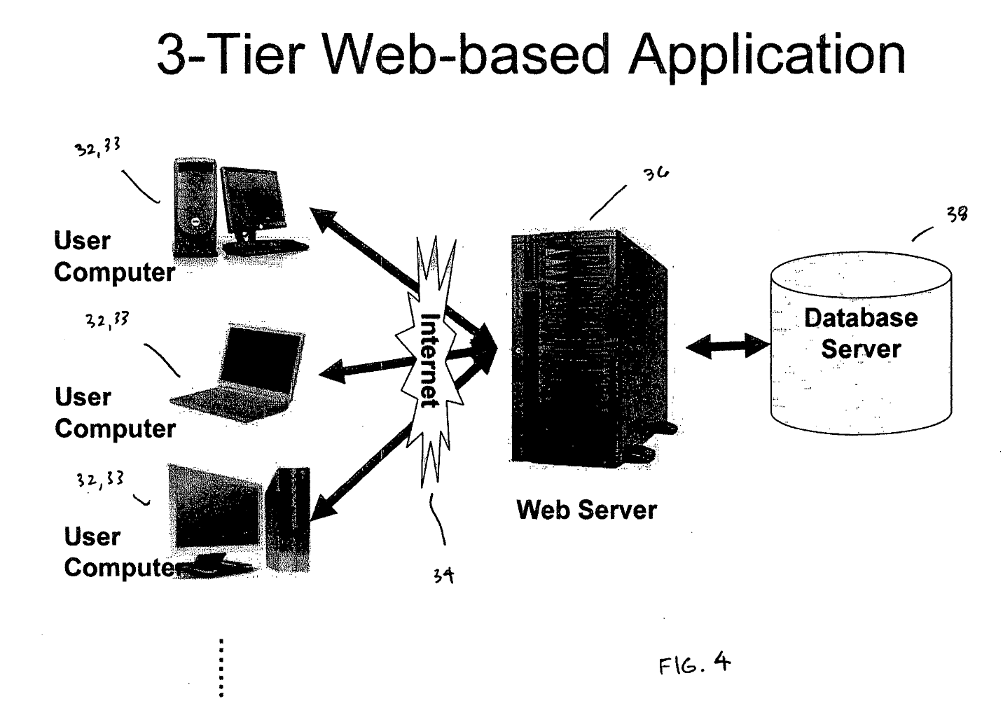

Implementing the TMI tool in a web environment would allow global vendors to easily become prospect product suppliers and thereby to maximize the benefits deploying the technology. With reference to FIG. 4, a computer system for implementing the TMI-based web model includes at least a first user computer 32 running a computer program that supplies data for populating the technical user input section 12 (see FIG. 1) with defined selection factors and desired values for each of the selection factors for a product to be selected. The system also includes at least a second user computer 33 running a computer program that supplies data for populating the product supplier input section 14 with product specifications relating to the defined selection factors. A web server 36 runs a server program and is interconnected with the first and second user computers 32, 33 via a computer network 34 such as the internet.

The web server 36 receives and processes the technical user input section data from the first user computer 32 and the product supplier input section data from the second user computer 33 to determine the technical merit index for each candidate product. The technical merit index is determined as discussed above. The web server 36 communicates the defined selection factors 16 (FIG. 1) to the second user computer (supplier) for display while concealing the desired values or ranking criteria 20. In a similar context, the web server 36 may communicate the technical merit index for each candidate product to the first user computer (purchaser) for display while concealing the technical merit index from the supplier computer. The web server 36 may additionally collect via the second user computer 33 supporting documentation from the supplier that corroborates the product specifications. All of the data are stored in a database server 38.

The purpose for supporting documentation is allow technical users to verify the data provided by suppliers. Examples of supporting documentation may include product catalogs, or any published documents relating to the candidate products.

With the TMI tool and method, the technical effect is to facilitate the selection of candidate products based on a more objective analysis than previously accomplished, and by enabling a TMI-based web model, additional suppliers can participate and multiple purchasers can process TMI data from a single source of product data.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of implementing a technical merit index tool over a global network to facilitate product selection, the method comprising:
(a) populating via the global network a technical user input section with defined selection factors and desired values for each of the selection factors for a product to be selected;
(b) populating via the global network a product supplier input section with product specifications relating to the defined selection factors; and
(c) determining a technical merit index for each candidate product based on a summation of normalized product specifications for each of the defined selection factors relative to the desired values.

2. A method according to claim 1, wherein step (b) is practiced by at least one product supplier, the method further comprising, prior to step (b), displaying the defined selection factors to the at least one product supplier, and concealing the desired values from the at least one product supplier.

3. A method according to claim 2, further comprising collecting supporting documentation from the at least one supplier that corroborates the product specifications.

4. A method according to claim 2, further comprising locally displaying the technical merit index for each candidate product, and concealing the technical merit index for each candidate product from the at least one product supplier.

5. A method according to claim 1, wherein step (a) is practiced by identifying the selection factors for a product to be selected, establishing a weight factor relating to an important level for each of the identified selection factors, and defining ranking criteria based on the desired values for each of the identified selection factors including at least two levels as high (H) and low (L).

6. A method according to claim 5, wherein the step of defining ranking criteria is practiced by defining ranking criteria for each of the identified selection factors including high (H), medium (M), low (L) and fail (F).

7. A method according to claim 6, wherein the ranking criteria for each level is H=1, M=0.5, L=0.1, and F=−100.

8. A computer system for implementing a technical merit index tool to facilitate product selection, the system comprising:
at least a first user computer running a computer program that supplies data for populating a technical user input section with defined selection factors and desired values for each of the selection factors for a product to be selected;
at least a second user computer running a computer program that supplies data for populating a product supplier input section with product specifications relating to the defined selection factors; and
a web server running a server program, the at least first and second user computers and the web server being interconnected by a computer network, the web server receiving and processing the technical user input section data and the product supplier input section data and determining a technical merit index for each candidate product based on a summation of normalized product specifications for each of the defined selection factors relative to the desired values.

9. A computer system according to claim 8, further comprising a database server communicating with the web server, the database server storing the technical user input section data, the product supplier input section data and the technical merit index for each candidate product.

10. A computer system according to claim 8, wherein the web server communicates the defined selection factors to the second user computer for display, and wherein the web server conceals the desired values from the second user computer.

11. A computer system according to claim 10, wherein the web server collects via the second user computer supporting documentation from the at least one supplier that corroborates the product specifications.

12. A computer system according to claim 10, wherein the web server communicates the technical merit index for each candidate product to the first user computer for display, and wherein the web server conceals the technical merit index for each candidate product from the second user computer.

13. A method of quantifying product technical merit to facilitate product selection, the method comprising:
(a) a technical user identifying selection factors for a product to be selected;
(b) the technical user establishing a weight factor relating to an importance level for each of the identified selection factors;
(c) the technical user defining ranking criteria for each of the identified selection factors including at least two levels as high (H) and low (L);
(d) the technical user populating via a global network a technical user input section including the selection factors identified in step (a), the weight factor for each of the identified selection factors established in step (b), and the ranking criteria defined in step (c);
(e) a supplier populating via the global network a product supplier input section with product specifications relating to the identified selection factors and supporting documentation;
(f) determining a technical merit index for each candidate product based on a summation of normalized product specifications for each of the identified selection factors weighted by the respective weight factor and multiplied by the respective ranking criteria; and
(g) selecting one of the candidate products based at least partly on a comparison the technical merit index of each candidate product.

14. A method according to claim 13, further comprising displaying the technical merit index for each candidate product to the technical user, and concealing the technical merit index for each candidate product from the product supplier.
